(19) United States
(12) Patent Application Publication
(10) Pub. No.: US 2016/0055243 A1
(43) Pub. Date: Feb. 25, 2016

(54) WEB CRAWLER FOR ACQUIRING CONTENT

(71) Applicant: UT Battelle, LLC, Oak Ridge, TN (US)

(72) Inventors: Songhua Xu, Oak Ridge, TN (US); Hong Jun, Oak Ridge, TN (US)

(21) Appl. No.: 14/832,393

(22) Filed: Aug. 21, 2015

Related U.S. Application Data
(60) Provisional application No. 62/040,686, filed on Aug. 22, 2014.

(51) Int. Cl. G06F 17/30

(52) U.S. Cl. CPC G06F 17/30864; G06F 17/30554; G06F 17/30867

(57) ABSTRACT

An adaptive web crawling system generates a first utility measurement based on web page snippets associated with individual search result items by crawling from a collection of web page crawling seeds and according to a specific user web crawling criteria. The system generates a second utility measurement based on features extracted from the full webpages downloaded according to the guidance of the first utility measurement results. A web page utility prediction function is introduced to forecast the second utility measurement based on the first utility measurement. The system adapts its priorities for web crawling based on the web page utility prediction function.

### RELATED APPLICATION

This application claims the benefit of priority of U.S. Provisional Pat. App. No. 62/040,686 filed Aug. 22, 2014, and titled “Web Crawler for Acquiring Online Content,” which is incorporated by reference.

### STATEMENT REGARDING FEDERALLY SPONSORED RESEARCH AND DEVELOPMENT

This invention was made with United States government support under Contract No. DE-AC05-00OR22725 awarded by the United States Department of Energy. The United States government has certain rights in the invention.

### BACKGROUND

1. Technical Field

This disclosure relates to a web crawler system and specifically, to an adaptive web crawler that adaptively acquires user desired content on and/or across the Internet.

2. Related Art

The Internet carries vast and enriching user generated content on a wide range of social, cultural, political, and other topics. Medical stories of patients are no exception to this trend. Collecting and mining such personal content can offer many valuable insights on patient's experiences with respect to disease symptoms and progression, treatment management, side effects, and effectiveness, as well as many additional factors and aspects of a patient's physical and emotional states throughout the whole disease cycle. The breadth and depth of understanding attainable through mining this voluntarily contributed web content can be expensive and time-consuming to capture via traditional data collection mechanisms.

Despite the merits and rich availability of user generated patient content on the Internet, collecting such information using a conventional query-based web search is labor intensive for many reasons. First, it is not clear what queries should be used to retrieve content accurately and comprehensively. And, manually examining and selecting the qualified search results require extensive human effort. Second, some medical providers have specific requirements regarding the user generated disease content they can process and collect. Query-based search engines cannot always support such requirements. To overcome these challenge, especially those found in the electronic health (e-health) research community as well as the broader bioinformatics communities, this disclosure describes a user-oriented web crawler, which can acquire user generated content satisfying particular content requirements with minimum manual intervention.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 shows an adaptive web crawler system interfacing a search engine.

FIG. 2 shows the architecture of an adaptive web crawler.

FIG. 3 shows the adaptive web crawler and its computational data flow.

FIG. 4 is a performance comparison between the disclosed web crawler and a peer method processing breast cancer data.

FIG. 5 is a performance comparison between the disclosed web crawler and a peer method processing lung cancer data.

### DETAILED DESCRIPTION OF THE PREFERRED EMBODIMENTS

This disclosure describes new web crawler systems (hereinafter refers to web crawler methods too) that leverages search engine indexes to massively and aggressively harvest candidate target crawling links, coupled with a parallel crawler navigation module that performs elaborate, user-oriented crawling utility prediction and utility-driven crawling priority determination. The web crawler balances the time cost between repeatedly training a crawling utility predictor using dynamically identified machine learning and the actual time spent on crawling the web. The new crawler includes an autonomous query composition and suggestion function, built upon content-based mining of exemplary search results. Compared to existing topic-based focused crawlers, the new web crawler performs function without predefined topic ontology. The web crawler efficiently and effectively acquires any content that matches the user's needs. This function enables users to harvest relevant content comprehensively without the manual effort of composing explicit search queries. Some web crawlers include a feedback component that estimates the utility score of an arbitrary webpage. The estimated webpage utility score establishes criteria that the web crawler processes to render optimized crawling decisions. The web crawler system make use of a predictive feedback modules for webpage utility score estimation.

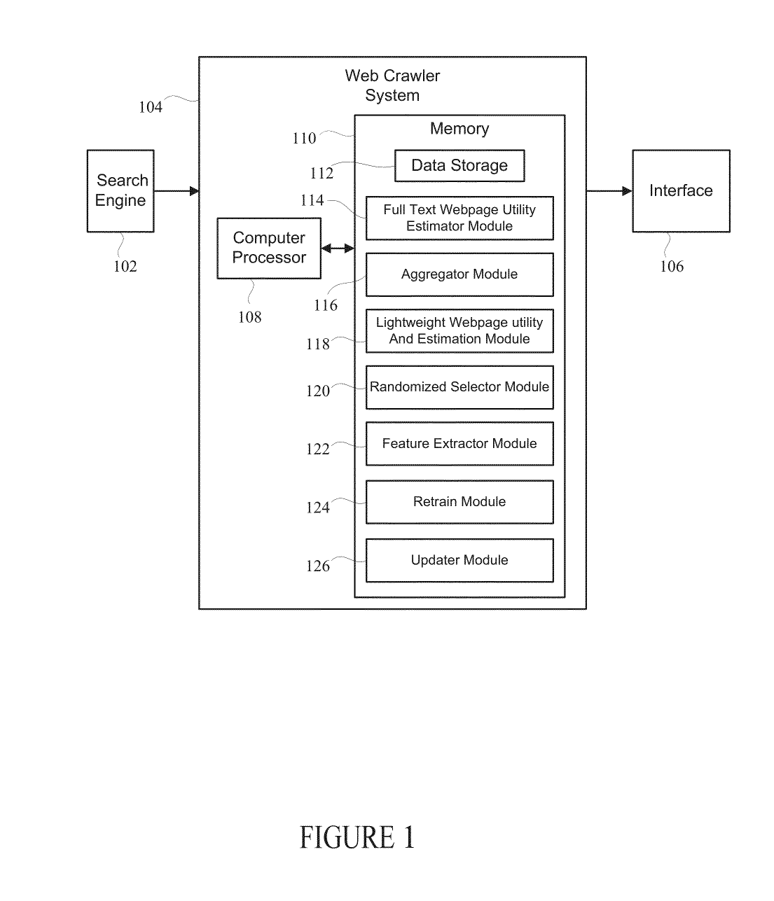

FIG. 1 illustrates a web crawler system 104 (also referred to as an adaptive web crawler system) that interfaces a search engine 102, and an output interface or interface module 106 (hereinafter referred to as an output interface). The web crawler system 104 receives indexed search results from the search engine 102, processes the indexed results, and outputs highly relevant on-line content through the output interface 106. In one implementation, the on-line content received by the output interface 106 is more aligned with the user's information acquisition needs than the indexed search results received by the search engine 102. The search engine 102 may comprise a program that searches for keywords or characters specified by a user in files and documents found on the Internet such as Google®. The output interface 106 is a point at which a connection is made between the web crawler system 104 and an external system. In some implementations it comprises software that enables the web crawler system 104 to communicate with external peripheral devices and/or software including menu driven or graphical user interfaces.

In FIG. 1, the web crawler system 104 includes a computer processor 108 and a memory device 110. The computer processor 108 may be implemented as a central processing unit (CPU), microprocessor, microcontroller, application specific integrated circuit (ASIC), or a combination of other type of circuits. In one implementation, the computer processor is a digital processor including a specialized microprocessor with an architecture optimized for the fast operational needs of web crawler processing. Additionally, in some implementations, the digital processor may be designed and customized for a specific application, such as medical research or a processing chip customized to crawl the web via a mobile/wireless communication device (e.g., a phone or tablet computer). The memory device 110 may include a magnetic disc, an optical disc, RAM, ROM, DRAM, SRAM, Flash and/or any other type of computer memory. The memory device 110 is communicatively coupled with the computer processor 108 so that the computer processor 108 can access data stored on the memory device 110, write data to the memory device 110, and execute programs and modules stored on the memory device 110.

The memory device 110 includes one or more data storage areas 112 and stores one or more databases, programs, or software modules in a non-transitory media. The data storage areas may include read only memory that retains the instructions that execute the web crawler functionality and a separate random access scratch pad memory that stores the output of the web crawler 104 an its programmable modules. The data and program modules are accessible to the computer processor 108 so that the computer processor 108 is particularly programmed to implement the adaptive web crawling functions. The programs may include one or more program modules executable by the computer processor 108 to process the output of a search engine 102 and transmit indexed content to the interface 106. For example, the program modules may include a full text webpage utility estimation module 114, an aggregator module 116, a lightweight webpage utility estimation module 118, a random selection module 120, a feature extractor module 122, a retrain module 124, and an update module 126. The memory device 110 may also store additional programs, modules, or other data to provide additional programming to allow the computer processor 108 to perform the functionality of the web crawler system 104. The described modules and programs may be parts of a single program, separate programs, or distributed across several memories and processors. Furthermore, the programs and modules, or any portion of the programs and modules, may instead be implemented in hardware.

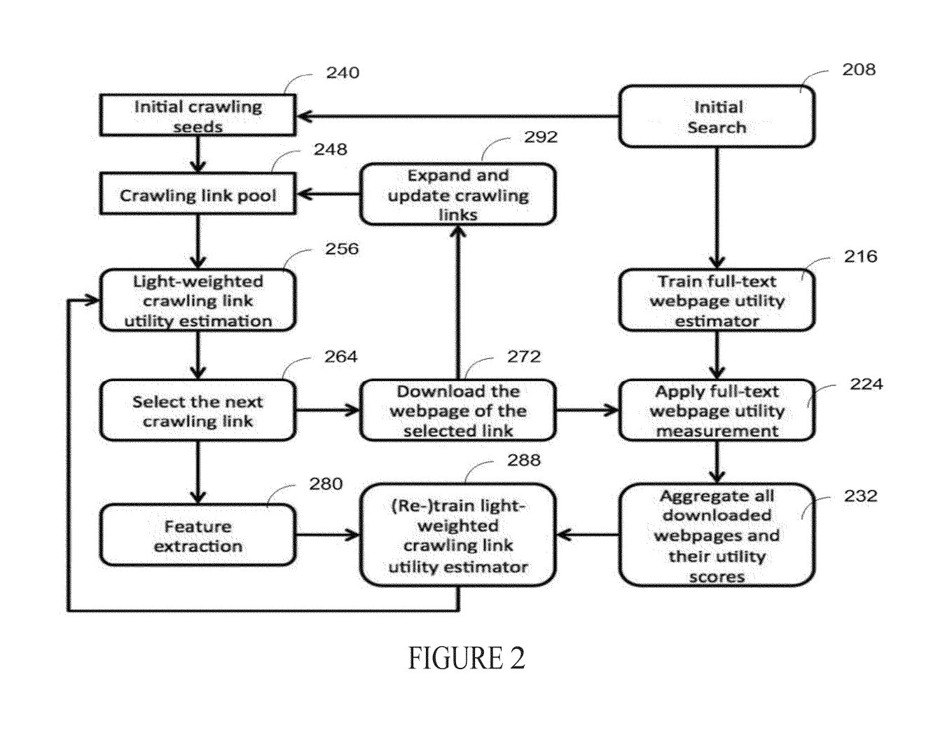

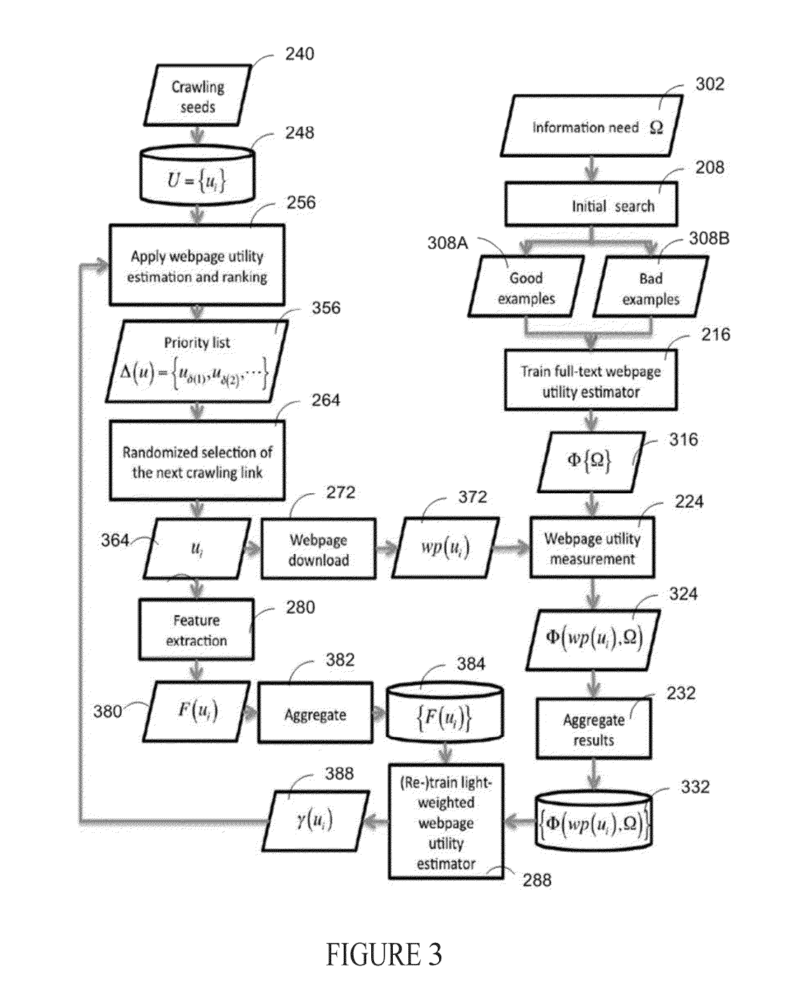

FIG. 2 is a flow chart illustrating the architecture of the adaptive web crawler 104. The functionality of FIGS. 2 and 3 may be achieved by the computer processor 108 accessing data from data storage 112 of FIG. 1 and by executing one or more of the modules 114-126 of FIG. 1. For example, the processor 108 may execute full text webpage utility estimation module at steps 216 and 316, the aggregator module 116 at steps 232 and 382, the lightweight webpage utility and estimation module 118 at steps 256 and 356, the feature extractor 120 at steps 280 and 380, the retrain, module 124 at steps 288 and 388. Any of the modules or steps described herein may be combined or divided into any smaller or larger number of steps or modules than what is shown in FIGS. 1-3.

The web crawler system 104 may begin the search and processing sequence shown in FIGS. 2 and 3 with a search for information on the Internet (or World Wide Web) at steps 302 and 208. The system may receive search results to train the full text webpage utility estimator 216. The search results may include user ratings of the user selected webpages as shown in steps 308A and 308B according to according to a user's information quality measurement criterion Ω. Each labelled utility score is a rational number in the range of [0, 1]. The higher the score value is, the better the quality of the webpage is as considered by the user evaluator.

At the beginning of the crawling session, no webpages have been crawled. Given a specific user web crawling need Ω, the user's first few queries of the Web are used to identify the initial seed webpages (or URLS) that initially populate the crawling link pool shown at steps 208, 240, and 248. With the returned search results, the user selectively identifies a few “good” search result webpages {wpᵢ^{bad}} as well as a few “bad” search result webpages {wpᵢ^{bad}} that fail to satisfy the user's needs at steps 308A and 308B. Given the initial set of positive and negative examples, the method trains the predictive model Φ(wpᵢ.Ω) for determining the utility score of a search result webpage wp, at steps 216 and 316 using the estimating utility score process described below.

During the on-line execution of the web crawler 104 at step 256, the process estimates the utility of a webpage wp(uᵢ) via a web link accessed through the crawling pool without requiring the system to download entire webpages. This preview portion of the webpage is called a snippet, which is descriptive of the content of the webpage and may highlight any related words used in the query without downloading the entire webpage. At steps 264 and 364, the system randomly selects the next link from a uniformly random distribution of URL candidates that are available. The probability distribution described in equation 6 below may be used to assign the probability distributions.

To construct the predictive model used to estimate or determine the utility score of a webpage adapted to a user's needs, the web crawling system 104 extracts from the webpage wp (accessed by URL link uᵢ shown at step 364) words or word phrases detected from: 1) the content words in the main body of an html file of a webpage wp, 2) words in the heading and subtitles of the html file, and 3) the anchor text embedded in the html file including the URL(s) associated with the anchor text at steps 280 and 380. The extracted features are aggregated at step 382 and stored at step 384. Processing the candidate key words used as features and the previously user labelled training examples provided in steps 302, 208, 308A, 308B, 216, and 316, the process retrains the light-weighted crawling link utility estimation.

At step 272 the web crawler system 104 downloads the actual webpage wₚ(uᵢ) that is pointed to by web link u, and measures the utility of the individual search result page Φ(wp(uᵢ).Ω) at steps 224 and 324 by applying the trained utility estimation function derived in steps 216 and 316. The difference between the function Y(wp(uᵢ).Ω) stored in memory 110 at step 332 and Φ(wp(uᵢ).Ω) stored in memory at 384 is that Φ(wp(uᵢ).Ω) is estimated using text features extracted from the full text of the webpage wₚ(uᵢ) after the webpage is downloaded while γ(wp(uᵢ).Ω) is estimated using text features extracted from the snippet text of the webpage wₚ(uᵢ) before the entire webpage is downloaded. At steps 288 and 388 the process updates the webpage utility estimation based on the feature extractions and the web page utility estimator, and user information requirements expressed in the form of pairs (F(uᵢ).Φ(wp(uᵢ), Ω).

One of the systems used to implement the web crawler system 104 is the feedback modules that estimate the utility score of a selected webpage. The estimated webpage utility scores guide the web crawler system 104 in making crawling decisions. For webpage wp and a certain user information the web crawler system 104 generates and executes the predictive model Φ that is capable of determining the utility score of webpage wₚ according to a specific user web crawling need Ω. The derived score is denoted as Φ(wp.Ω) ∈ [0,1], where the higher the score the more useful the webpage is considered. To extract words in the main body of an html file, the web crawler may use Boilerpipe Java. To obtain the heading and subtitles of an html file, the web crawler system 104 may implement a html parser that extracts all or nearly all of the text enclosed in the html blocks of <h? id=“ . . . ”> . . . </h?> where ? stands for an integer number in the range of [1, 6]. For example, from the html block <hl id=“sectiontitle”> Breast Cancer </hl>, the web crawler system extracts the heading text of “Breast Cancer.” Similarly, to obtain the anchor text, one implementation of the web crawler system 104 uses an html text parser that collects the annotation text associated with hypertext links embedded in an html file. From these processes, the web crawler system 104 derive the three sets of text from webpage wₚ, which are respectively denoted as T₁(wₚ), T₂(wₚ), and T₃(wp).

Some implementations of the the web crawler system 104 executes a Rapid Automatic Keyword Extraction algorithm (RAKE) to identify a set of key words or phrases from each one of the text sets, T₁(wp), . . . , T₃(wp). The results are respectively denoted as kw_{i,j}(wp) (i=1,2,3: j=1, . . . , nᵢ) where nᵢ denotes the number of distinct keywords extracted by the RAKE algorithm from the text set Tᵢ(wp) and the subscript j in the notation kw_{i,j}(wp) indexes these keywords individually. To train the webpage utility estimator Φ(wp.Ω) following a supervised learning based process, the web crawler system 104 also processes as set of previously labelled samples. For this purpose, the web crawler system 104 initially collects the detected keywords from webpages in wₚ which may be denoted as kw={kw_{i,j}^{k}|wpₖ ∈ wp}, where kw_{i,j}^{k} is a short notation for kw_{i,j}(wpₖ). To train the webpage utility estimator Φ(wp.Ω), the web crawler system 104 processes webpages previously rated according to a specific user's web crawling criterion Ω. Each labelled utility score, denoted as Φ(wpₖ.Ω), is a rational number in the range of [0, 1]. The higher the score value is, the better the quality of the webpage is as considered by the evaluator.

Given the substantial imbalance between the number of candidate keywords that may be used as features for webpage wₚ and the availability of labelled training samples, to train the utility estimator module 114 some implementations apply a feature selection procedure to reduce the number of candidate keyword features. This filtering process may occur in two steps. In the first step, the process deletes infrequently used keywords whose occurrence values are below a certain empirically programmed threshold, which may be set to 5 in some cases. After the infrequent keyword filtering step, the set of remaining keywords may be denoted as kw. In the second process step of the keyword reduction process, the process analyzes the odd ratios of keywords with respect to the labelled training set. Specifically, for each candidate keyword kw_{i,j}^{k} ∈ k̅w̅ and a given threshold τ∈ [0,1] the process derives a keyword's odd ratio v(kw_{i,j}^{k}.Ω.τ,wp) with respect to the labelled training set as shown in equation 1.

$$ψ ( {kw}_{i , j}^{k} , Ω , τ , wp ) = \frac{{p}_{11} ( {kw}_{i , j}^{k} , wp ) {p}_{00} ( {kw}_{i , j}^{k} , wp )}{{p}_{01} ( {kw}_{i , j}^{k} , wp ) {p}_{10} ( {kw}_{i , j}^{k} , wp )} , \qquad ( 1 )$$

p₁₁(kw_{i,j}^{k}.wp) is the number of webpages in wp that contain the keyword kw_{i,j}^{k} and whose previously labeled utility score is above the threshold, e.g., p₁₁(kw_{i,j}^{k}.wp)=|{wpₓ ∈ wp|kw_{i,j}^{k} ∈ wpₓ, Φ(wpₓ,Ω)≧τ}|: p₁₀(kw_{i,j}^{k}.wp) is the number of webpages in wp that contain the keyword kw_{i,j}^{k} and whose previously labeled utility score is below the threshold, e.g., p₁₀(kw_{i,j}^{k}.wp)=|{wpₓ ∈ wp|kw_{i,j}^{k} ∪ wpₓ, Φ(wpₓ.Ω)<T}|. Similarly, the process defines P₀₁(kw_{i,j}^{k}.wp) and P₀₀(kw_{i,j}^{k}.wp) which are the counterparts of p₁₁ and p₁₀ with the only difference being that the webpages considered now do not contain the keyword kw_{i,j}^{k}. That is P₀₁(kw_{i,j}^{k}.wp)=|{wp_{z} ∈ wp|kw_{i,j}^{k}∉ wpₓ, Φ(wpₓ,Ω)≦T}| and P₀₀(kw_{i,j}^{k}.wp)=|{wpₓ ∈ wp|kw_{i,j}^{k} ∪ wpₓ, Φ(wpₓ.Ω)<T}|. The process ranks all the candidate keywords kw_{i,j}^{k}∈ k̅w̅ in a descendant order according to their respective odd ratios derived from equation (1). When training the webpage utility estimation module using a specific machine learning method, the processes progressively admit keywords as features into the module one-by-one until the testing performance of the trained module as obtained through about a tenfold cross-validation declines from the peak testing performance by more than about 5%. The process may then retrospectively remove all the keyword features admitted after the model achieves its peak performance moment. In some implementations an additive regression process was executed.

As explained through FIGS. 2 and 3, the web crawler system 104 dynamically deter mines a priority list u={u₁, u₂, . . . , u₃} by applying the web page utility estimation and ranking. The ranking function is shown by the notation δ( ), and when indicating a ranking of all the candidate webpages to be crawled is shown by u_{δ}(i) which represents the URL of the i-th webpage that the web crawler system 104 visits since the beginning of a crawling session. As discussed, exhaustively downloading all the links may take a long time and many links may not be relevant to the end user's search. Hence in operation, given a priority list Δ(u) and a predetermined or limited downloading time, the web crawler system only downloads a header portion of the prioritized until the predetermined time lapses. To create the priority list the web crawler system 104 relies on heuristics to construct the ranking function. Given a web link u, and the actual download webpage wₚ found at that address, the web crawler system 104 measures the utility of the individual search result page Φ(wp(uᵢ), Ω) at steps 224 and 324 as shown through FIGS. 2 and 3. Using text features F(uᵢ) extracted from the web link's uᵢ, URL, a running head text, and a brief descriptive of the content of the webpage wₚ the web crawler system 104 predicts the value of the above three types of information T₁(wₚ), T₂(wₚ), and T₃(wp). In predicting the value of the utility of the individual search result page Φ(wp(uᵢ),Ω), the web crawler system processes the text features F(uᵢ) which includes all the individual non-stop words in the snippet text of the webpage wₚ(uᵢ). The prediction function is expressed as equation 2.

Y(wp(uᵢ), Ω): F(uᵢ)→Φ(wp(uᵢ), Ω), (2)

As explained, the difference between the function Y(wp(uᵢ).Ω) stored in memory 110 at step 332 and Φ(wp(uᵢ).Ω) stored in memory at step 384 is that Φ(wp(uᵢ), Ω) is estimated using text features extracted from the full text of the webpage wₚ(uᵢ) after the webpage is downloaded, while Y(wp(uᵢ).Ω) is estimated using text features extracted from the snippet text of the webpage wₚ(uᵢ) before the entire webpage is downloaded.

In some implementations, to obtain a sample pair of (F(uᵢ).Φ(wp(uᵢ), Ω)) for training prediction function Y (shown in step 388) there is a penalty in terms of the link visitation time, which may be non-trivial in some cases. From a runtime efficiency perspective, it may desirable to use Y(wp(uᵢ), Ω) in place of Φ(wp(uᵢ), Ω) if some error may be tolerated. In such implementation let ψ(Y, t) be the prediction error of the prediction function Y at a given time moment t. With the progression of a crawler's execution in any crawling session, more training examples will be accumulated, which will help train a more accurate predictor.

To establish the optimal URL visitation planning task across a pool of candidate URLs u={u₁, u₂, . . . , uₓ} that is dynamically growing, the web crawler system 104 establishes a URL visitation trajectory V(t₀, tₓ)=(u_{δ(1)}, u_{δ(2)}, . . . , u_{δ(n}_{ₓ}₎) that maximizes the total utility score of all the URLs visited since the beginning of a crawling session. Here, {u_{δ(1)}, u_{δ(2)}, . . . , u_{δ(nx})} is the URL sequence that the web crawler 104 manages to visit under the visitation trajectory V(t^{x}) within a given time duration [t₀, tₓ]. And, it should be noted that the pool of candidate URLs is dynamically growing because each time a webpage wₚ(uᵢ) is pointed to by the URL web link uᵢ is visited, the web crawler 104 may discover new URLs from the webpage wₚ(uᵢ), which is then extracted and added into the URL pool U. For reference, this disclosure denote the snapshot of the pool of candidate URLs awaiting to be crawled at the time moment of t₁ as U(tₓ). So, at the beginning of a crawling session, i.e., at the initial time moment t₀, no webpages are crawled and the corresponding candidate URL pool U(t₀) is the pool of seed webpage URLs for launching the web crawler system 104. Accordingly, the optimization objective may be expressed as equation 3 and the objective function is expressed as equation 4.

$$\begin{matrix}{\text{maximize}}_{𝒱 ( {t}_{0} , {t}_{x} ) = ( {u}_{δ ( 1 )} , … , {u}_{δ ( {n}_{x} )} )} 𝒢 ( {t}_{0} , {t}_{x} , 𝒱 ( {t}_{0} , {t}_{x} ) ) , \\ 𝒢 ( {t}_{0} , {t}_{x} , 𝒱 ( {t}_{0} , {t}_{x} ) ) = {\sum }_{i = 1}^{{n}_{x}} Φ ( wp ( {u}_{δ ( i )} ) , Ω ) subject to \text{:} & ( 3 ) \\ {\sum }_{i = 1}^{n} T ( {u}_{δ ( i )} ) \leq {t}_{x} - {t}_{0} ; \\ {u}_{δ ( i )} ∈ 𝒰 ( {\sum }_{j = 1}^{i - 1} T ( {u}_{δ ( j )} ) ) ( i = 1 , … , n ) . & ( 4 )\end{matrix}$$

Note that in equation 4, the first constraint, Σᵢ₌₁ⁿT(u_{δ(i)})≦tₐ−t₀, ensures that visiting all the URLs along the visitation trajectory V(t₀, tₓ) will not take the total length of the allocated time. The second constraint u_{δ(i )}∈U(Σᵢ₌₁ⁱ⁻¹T(uₛ₍ⱼ₎)) assures that at any moment when the web crawler system executes the visitation trajectory V(tₒ, tₓ), which the system assume to be the moment after the (i−1)-th URL in V(tₒ, tₓ) is visited but before the i-th link is to be visited, the next URL the crawler is going to visit shall only come from the current candidate URL pool u(Σⱼ₌₁ⁱ⁻¹T(u_{δ(i)})) where Σⱼ₌₁ⁱ⁻¹T(u_{δ(j)}) is the corresponding time stamp for the moment. Also, by definition δ( ) is a ranking function, which implies that i≠j [symbol] δ(i)≠δ(j). It should be noted that the target function G(tₒ, tₓ, V(tₒ, tₓ)) defined in equation 4 may not be directly employed in the actual optimization process during runtime because to obtain the information Φ(wp(u_{δ(i)}).Ω), the crawler first visits the URL u_{δ(i)}, which would incur the cost of link visitation time T(u_{δ(i)}). Expecting to have the full knowledge of Φ(wp(u_{δ(i)}).Ω) for all web links uᵢ involved in the optimal planning process may be impractical because this would require the crawler to visit every link in the candidate URL pool, which is highly undesirable. Taking into account the considerable amount of time cost for “knowledge acquisition” in terms of the time required for downloading the webpage wp(u_{δ(i)}) to derive the value of predictive model Φ(wp(u_{δ(i)}.Ω) alternative implementations revise the objective function G(tₒ,tₓ, V(tₒ, tₓ)) in equation 4 and formulate an alternative objective function G(t₀,tₓ, V(tₒ, tₓ)) that may be evaluated computationally in real time. For simplicity, this disclosure uses the short notation of Tᵢ to denote Σⱼ₌₁ⁱ⁻¹T(u_{δ(j)}), which indicates the time moment immediately after the first i−1 URLs have been visited by the crawler in a crawling session:

$$maximize v ( {t}_{0} , {t}_{x} ) = ( {u}_{δ ( 1 )} , … , {u}_{δ ( {n}_{x} )} ) \hat{𝒢} ( {t}_{0} , {t}_{x} , 𝒱 ( {t}_{0} , {t}_{x} ) ) = {\sum }_{i = 1}^{{n}_{x}} \frac{{\sum }_{k = 1}^{10} {n}_{k} ( wp ( {u}_{δ ( i )} ) , {T}_{i} ) ( 1 - {ψ}_{k} ( wp ( {u}_{δ ( i )} ) , {T}_{i} ) ) ϒ ( wp ( {u}_{δ ( i )} ) , Ω , {T}_{i} )}{10} , \\ subject to : \\ {\sum }_{i = 1}^{n} T ( {u}_{δ ( i )} ) \leq {t}_{x} - {t}_{0} ; {u}_{δ ( i )} ∈ u ( {T}_{i} ) ( i = 1 , … , n ) . \qquad ( 5 )$$

To understand the design of (5), for a given utility estimate for a webpage [symbol] (wp(u_{δ(i)}).Ω, Tᵢ), for its k-th relative error interval [−ψₖ(wp(u_{δ(i)}), Tᵢ), ψₖ(wp(u_{δ(i)}), Tᵢ)], the corresponding lowest utility estimate (1−ψₖ(wp(u_{δ(i)}), T₁))Y(wp(u_{δ(i)}), Ω, Tᵢ) is with the estimate confidence being ηₖ(wp(u_{δ(i)}), Tᵢ). This estimate is a very conservative measure regarding the utility scores harvested from crawled webpage as the actual relative error may not be as high as the maximum value, ψₖ(wp(u_{δ(i)}). Tᵢ), in the error interval. By averaging such estimates for all ten error intervals, the process derives a conservative estimation of the confidence modulated utility score for the i-th webpage crawled. Adding up all nₓ webpage wₚ the web crawler system 104 acquires along the visitation trajectory, the process may derive the overall confidence-modulated utility score for all the webpages acquired by the crawler during the period of [t₀, tₓ] under the a very conservative estimate.

An alternative uses computational optimization algorithmic approach than the objective function of equation 4. In this alternative t, comprises a moment when the algorithm needs to probabilistically choose a crawling target. At this moment, the algorithm chooses from the then candidate URL pool U(t_{z}) a web link uᵢ with the probability of

$${p}_{i} ( {T}_{Z} ) = \text{?}$$

$$\text{?} \text{indicates text missing or illegible when filed}$$

where qᵢ(t_{z}) is expressed as equation 6.

$${Q}_{I} ( {T}_{Z} ) = {\sum }_{k = 1}^{10} {n}_{k} ( wp ( {u}_{i} ) , {t}_{z} ) ( 1 - {ψ}_{k} ( wp ( {u}_{i} ) , {t}_{z} ) ) ϒ ( wp ( {u}_{i} ) , Ω , {t}_{z} ) \qquad ( 6 )$$

Note that before some implementations of the web crawler system 104 a sufficient number of samples of the assigned utility of the individual search result page Φ(wp(uᵢ).Ω) the process cannot train a reliable model to serve as the prediction function Y(wp(uᵢ).Ω) because the training data required of the prediction function Y(wp(uᵢ).Ω) is in the form of pairs of text features and utility of the individual search result page expressed as (F(uᵢ), Φ(wp(uᵢ).Ω). Therefore, the web crawler system in these implementations assigns a uniformly random distribution over all candidate URLs that are currently available. That is, the system sets

$${p}_{i} ( {t}_{z} ) = \text{?}$$

$$\text{?} \text{indicates text missing or illegible when filed}$$

in one implementation, the system processes equation 6 to assign probability distributions of {pᵢ(tₓ)} when the web crawler system has acquired more than about 1000 webpages in a crawling session.

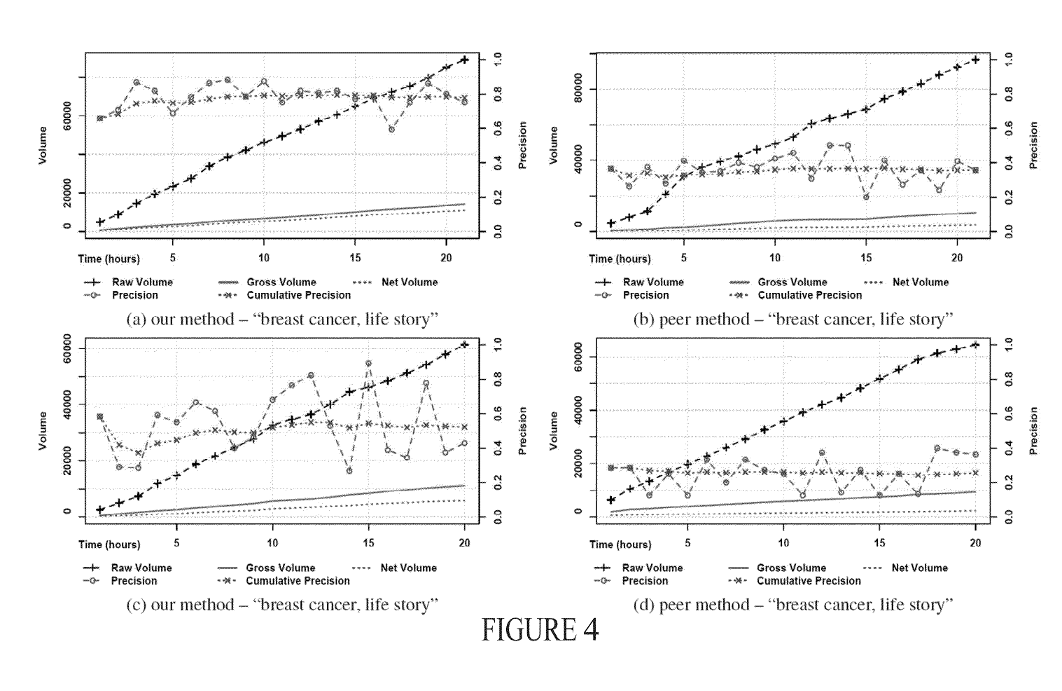

To explore the potential of the disclosed web crawler system, an evaluation process conducted two crawling tasks where the process respectively collected patient generated online content regarding two cancer research topics: one on breast cancer patients and their lifestyle choices and the other on lung cancer patients with history of smoking. Both crawling tasks are relevant for addressing epidemiological type questions by analyzing online personal stories of cancer patients who meet the specific selection criteria imposed by the cancer researcher. For the breast cancer study, 133 positive and 875 negative exemplary search results were collected by a researcher to initialize the web crawling system. These sample results were mostly collected by manually searching established cancer related forums such as the American Cancer Society's cancer survivor network forum ACS (2013). To assess the performance advantage of the disclosed web crawler system with respect to the state-of-the art, the evaluation process compared the disclosed web crawler system 104 to an adaptive web crawlers proposed by Barbosa and Freire as a peer crawling method. The evaluation process implemented the prototype system of the peer method according to the design and all technical details disclosed. In the comparative evaluation, the same set of example search results is used to train and initialize the peer crawling method. The runtime performance of both crawlers is reported in FIG. 4 for both case studies. FIG. 4 shows the total amount of webpages crawled (Raw Volume), the amount of web crawling results obtained by a crawler that are estimated relevant to the current crawling objective wherein the relevance estimation is performed by the crawler's built-in self-assessment capability (Gross Volume), and the amount of satisfactory search results obtained as judged by a human end user (Net Volume). In addition, the evaluation also shows the temporal precision (Precision) and cumulative precision (Cumulative Precision) of either crawler throughout the whole crawling process as measured via a sampling based human evaluation procedure. Due to the large volume of crawling results produced, it is prohibitively expensive to ask a cancer researcher to manually evaluate the quality of each individual result for deriving the precision of either crawler. Therefore, the evaluation process employed a sampling based manual evaluation procedure wherein the researcher manually evaluated the quality of every other 50 crawling results using binary labels (1: relevant, 0: irrelevant) regarding the relevance of the sampled result. Comparing between (a) and (b) in FIG. 4, the results show that the peer method obtains a slightly larger raw crawling volume than the disclosed web crawler 104. This qualitative difference is weakly reversed when it comes to the gross crawling volume, suggesting that the disclosed web crawler 104 is better in guiding itself to encounter more useful webpages than the peer approach. More importantly, the precision attained by the new crawler, both in terms of its temporal precision and cumulative precision as evaluated by the human searcher, is consistently superior to that of the peer method. Consequently, the net crawling amount obtained by the disclosed web crawler 104 is substantially more abundant than that of the peer method.

TABLE 1
Quantitative comparison between the performance of our crawler
and that of the peer method (Barbosa and Freire (2007)) in terms
of the net volumes of user desired online content harvested by each
crawler for progressively extended periods of crawling time.

| Comparison | Cumulative crawling time (hour) | | | | |
|---|---|---|---|---|---|
| method | 1 | 6 | 11 | 16 | 20 |

(a) Crawling for the breast cancer study (enriched training set)

| | | | | | |
|---|---|---|---|---|---|
| Peer crawler | 225 | 1021 | 2403 | 2904 | 3607 |
| Our crawler | 506 | 3085 | 5732 | 8691 | 10628 |
| Rate (our/peer) | 2.25 | 3.02 | 2.39 | 2.99 | 2.95 |

(b) Crawling for the breast cancer study (reduced training set)

| | | | | | |
|---|---|---|---|---|---|
| Peer crawler | 562 | 1125 | 1565 | 1964 | 2403 |
| Our crawler | 284 | 1569 | 3184 | 4830 | 5800 |
| Rate (our/peer) | 0.51 | 1.39 | 2.03 | 2.46 | 2.41 |

(c) Crawling for the lung cancer study (enriched training set)

| | | | | | |
|---|---|---|---|---|---|
| Peer crawler | 166 | 883 | 1620 | 2325 | 3263 |
| Our crawler | 404 | 3124 | 5286 | 6810 | 8130 |
| Rate (our/peer) | 2.43 | 3.54 | 3.26 | 2.93 | 2.49 |

(d) Crawling for the lung cancer study (reduced training set)

| | | | | | |
|---|---|---|---|---|---|
| Peer crawler | 107 | 1104 | 2021 | 2643 | 3404 |
| Our crawler | 168 | 1409 | 2285 | 3302 | 4881 |
| Rate (our/peer) | 1.57 | 1.28 | 1.13 | 1.25 | 1.43 |

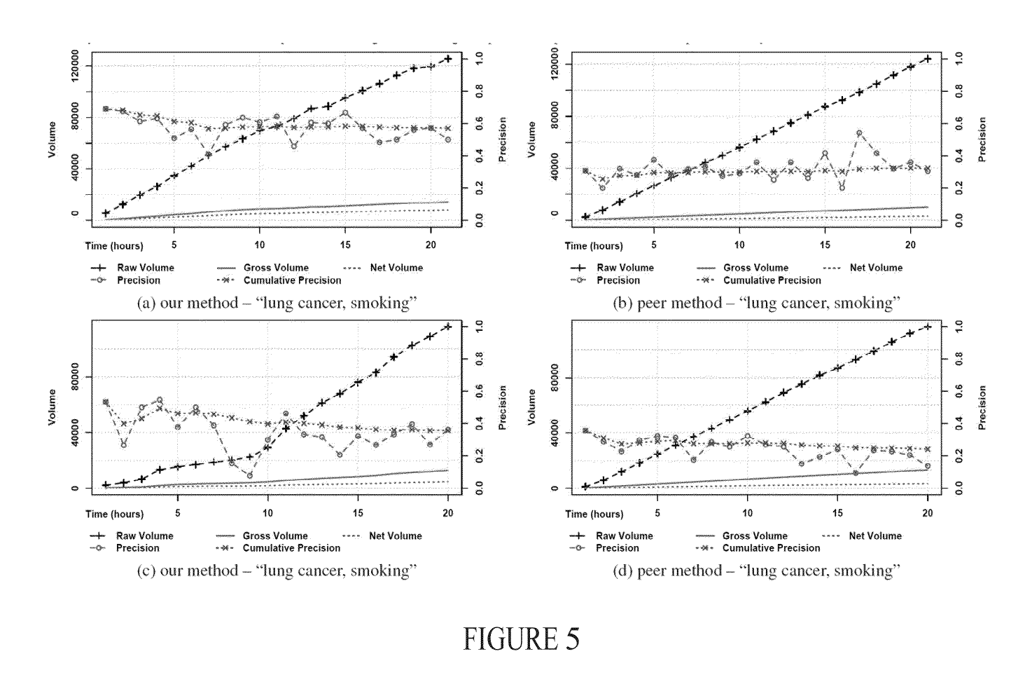

Table 1 reports the quantitative difference between the two methods in terms of their net crawling volumes. To further assess the performance advantage of the web crawler system 104 the evaluation process performed a secondary evaluation for the breast cancer case study by having the adaptive crawler system 104 to repeat the search using a substantially reduced number of exemplar search results. Specifically, the crawler was initialized using only 67 positive and 438 negative search results. The results are also shown in the FIG. 5, which demonstrate a very similar qualitative performance difference between the two methods in comparison: 1) the peer method encounters more webpages than the disclosed web crawler system in that it obtains a larger raw crawling volume than the disclosed system; 2) the gross volume of the two systems is comparable, with a slight advantage achieved by the disclosed web crawler system 104; 3) the precision of the disclosed web crawler system 104 is substantially higher than that of the peer method, leading to a substantially larger net volume of results crawled by our approach. Table 1 also shows a quantitative comparison between the web crawlers in terms of their effectiveness and time efficiency of harvesting user desired online content for two cancer case studiesone on breast cancer and the other on lung cancer research using both an enriched set and a reduced set of user labeled exemplar search results to train each crawler respectively. Table 1 further reports the number of distinct webpages crawled that are relevant to the specific information needs and requirements of either study, referred to as “net volumes,” after executing each adaptive crawling process for progressively extended periods of time, namely after 1, 6, 11, 16, and 20 hours of crawling. To derive the end-user evaluated net volumes of online content obtained up to each snapshot moment of a crawling process, the evaluation process adopted the aforementioned selective sampling-based manual evaluation strategy. As explained above, both our adaptive web crawler system 104 and the state-of-the-art peer crawler were trained and initialized using the same set of seed URLs and user labeled exemplar search results for capturing and understanding the type and scope of online content desired by e-health researchers in either crawling evaluation. Instead of reporting the raw volumes of web content acquired by the two crawlers respectively, the evaluation process compares the net volumes of selectively acquired online content because the latter volumes more truthfully indicate the amount of acquired web content relevant and useful for e-Health researchers in either study. The last row of each sub-table also reports the rate of harvesting user desired online content by the web crawler system 104 with respect to the harvesting rate of the peer crawler at each crawling snapshot moment. In both comparative studies, the adaptive crawler is consistently superior to the peer method. In addition, the comparative study using a reduced set of user labeled sample web search results further supports the advantage of the disclosed web crawler system 104. Namely, the the web crawler system 104 can be initialized with a small set of exemplar search results for quick launch, and is still capable of obtaining superior crawling performance.

Similarly, for the lung cancer case study, 73 positive and 700 negative webpages from sites such as the Lung Cancer Support Community were manually collected as exemplar search results to initialize the system. For comparison purposes, the evaluation process further conducted a peer crawling session by using a reduced set of human labels consisting of 50 positive and 400 negative sample webpages. The runtime performance of the web crawler system 104 for the new crawling task under the two initialization conditions is reported in FIG. 5 as well as table 1. Similar to the breast cancer case study, the web crawler system 104 demonstrates clear advantage over the peer method for the lung cancer case study as well. As illustrated in FIG. 5, for the lung cancer study, the precision attained by the web crawler system 104, both in terms of its temporal precision and cumulative precision according to the evaluation by the human end user, is consistently superior to that of the peer method. Benefited by this prevailing advantage of the web crawler system 104 in more precisely locating and acquiring online content relevant to the specific crawling needs, the net crawling amount by the new crawler consistently surpasses that of the peer method for both crawling sessions using the enriched and reduced training sets of user labeled exemplary search results. This conclusion may also be quantitatively verified by the comparative rate of harvesting speeds between the two crawling systems as reported in the last rows of the sub-tables (b) and (d) in table 1. The evaluation process further observe a that when trained using the enriched set of user labeled exemplary search results, the web crawler system 104 obtains a roughly comparable rate of raw crawling volumes as the peer method. Yet, when trained using the reduced set of user labeled search results, for the initial ten hours of crawling, the web crawler system 104 exhibits a slower rate of harvesting the raw crawling volume than the peer method. However, as the crawling time keeps increasing the web crawler system 104 catches up with the peer crawler in terms of the raw crawling volume. At the end of the twenty-one hours of crawling, the raw volumes of results obtained by both systems are comparable. For the initial slower rate of acquiring the raw crawling volume, recalling the early conclusion that the web crawler system 104 consistently sustains a superior crawling precision than the peer method, it seems that the web crawler system 104 favors precision rather than the raw crawling volume as compared with the peer crawler. That is, the evaluation process suggests that the web crawler system 104 may spend more time in executing its adaptive web crawling logics to determine on the-fly web crawling plan for the current crawling task rather than the alternative strategy of performing more operations of raw web crawling with a less deliberated and planned adaptive crawling plan. Consequently, the web crawler system 104 may exhibit a slower rate of web crawling than the peer method. As verified by the performance evaluation results reported in FIG. 5 and table 1, such prioritized execution of the planning process for adaptive web crawling yields more effective overall return in terms of the net volume of crawling results obtained. Such tactical crawling strategy determination may not be necessary or evident when the amount of available user-labeled exemplary training samples is abundant; yet when the samples are scarce or less informative, extra planning in the adaptive crawling process may be more important for the web crawler system 104 compared to the peer method. For the second phase of the gradual speedup of the proposed adaptive crawler, a potential reason is that when more online content has been crawled and thus becomes available for re-training the light-weighted crawler navigation model [symbol] (wp(uᵢ).Ω.t_{≈}) , the utility of frequent model re-training declines. Thus, by shifting more time from the model re-training to actual web crawling operations, the disclosed crawler can obtain the raw volume faster. A second reason for the accelerated rate of the raw crawling volume is that after the web crawler system 104 has accumulated a critical mass amount of online content, such an intermediate result set may lead to a more effective predictive function [symbol] (wp(uᵢ).Ω.t_{≈}) for guiding the web crawler system to visit webpages with fast link visitation time.

The methods, devices, systems, and logic described above may be implemented in many different ways in many different combinations of hardware, software or both hardware and software. For example, all or parts of the system may diagnose software or circuitry in one or more controllers, one or more microprocessors (CPUs), one or more signal processors (SPU), one or more graphics processors (GPUs), one or more application specific integrated circuit (ASIC), one or more programmable media or any and all combinations of such hardware. All or part of the logic, specialized processes, and systems described may be implemented as instructions for execution by multi-core processors (e.g., CPUs, SPUs, and/or GPUs), controller, or other processing device including exascale computers and computer clusters that execute software stored on a non-transitory media.

The methods, devices, systems, and logic disclosed improves another technology and technical field as it shows a greatly improved accuracy in discovering and acquiring user desired on-line content especially in the health field. Further, the web crawler system 104 improves the function of the computer itself as it conserves computing resources, reduces bandwidth, and improves efficiency through its machine intelligence. The machine intelligence saves hardware resources and computing time (improving efficiency) in delivering content meeting a user's customized and frequently unique needs and expectations. The web crawler system 104 identifies and prioritizes content and executes links from a priority list (step 356) it generates to crawl accomplishing many significant functions. In one aspect the system downloads field specific user defined content fulfilling the crawling process by delivering the content the user is seeking to acquire in minimal time. In a second aspect, the web crawler system assesses the snippets of content (a real time quality assessment, in some implementations) by measuring text features F (u) and executing prediction functions T(0, 1. . The systems leverage the prediction function T by indexing and prioritizing the web page utility. Such functions are meaningful applications (and when claimed, meaningful limitations) to the technological environment of the repetitive and time consuming task of searching and gathering relevant files and documents served on the Internet and in some implementations storing them in database that are resident to database servers and memory that users can retrieve. In those implementations accomplishing some or all of the process steps and processing shown in FIGS. 1 - 3 in real time, (or real-time), a real time operation comprises an operation matching a human's perception of time or a virtual process that is processed at the same rate (or perceived to be at the same rate by a user) as a physical or an external process. Here, the physical or external process comprises an Internet session or session, which is the time during which the web crawler system 104 maintains a connection with other communicating devices in which the program modules may accept input information such as the search results or indexed search results provided by a search engine. An Internet session is set up or established at a certain point in time, and then torn down at some later point in time. It is the time during which a conversation or meeting between the web crawler system 104 is communicating with one more external or remote computing devices.

The term “coupled” disclosed in this description may encompass both direct and indirect coupling. Thus, first and second parts are said to be coupled together when they directly contact one another, as well as when the first part couples to an intermediate part which couples either directly or via one or more additional intermediate parts to the second part. The term “substantially” or “about” may encompass a range that is largely, but not necessarily wholly, that which is specified. It encompasses all but a significant amount. When devices are responsive to commands events, and/Or requests, the actions and/or steps of the devices, such as the operations that devices are performing, necessarily occur as a direct or indirect result of the preceding commands, events, actions, and/or requests. In other words, the operations occur as a result of the preceding operations. A device that is responsive to another requires more than an action (i.e., the device's response to) merely follow another action.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. An adaptive web crawling process comprising:
generating a first utility measurement of an individual search result page by a computer processor based on web page snippets associated with individual search result items by crawling from a collection of web page crawling seeds and according to a specific user web crawling criteria;
generating a second utility measurement based on features extracted from fully downloaded webpages by the computer processor according to the guidance of the first utility measurement;
generating a web page utility prediction function by the computer processor that forecasts the second utility measurement based on the first utility measurement; and
adapting web page priorities for web crawling by the computer processor based on the web page utility prediction function.

2. The process of claim 1 where the fully downloaded webpages comprise labeled results assigned by a user.

3. The process of claim 1 further comprising obtaining web page crawling seeds generated by a search engine.

4. The process of claim 1 where the first utility measurement is generated without predefining a topic ontology.

5. The process of claim 1 where the search result page is rendered by a search engine.

6. The process of claim 1 further comprising extracting the web page snippets without downloading entire web pages.

7. The process of claim 6 where the web page snippets comprises descriptive content of each of the entire web pages.

8. The process of claim 7 where the web page snippets are extracted from a main body of the web pages.

9. The process of claim of claim 7 where the web page snippets are extracted from a heading of the web pages.

10. The process of claim 7 where the web page snippets are extracted from an anchor text embedded in an html file and addresses associated with the anchor text of the web pages.

11. The process of claim 7 where the page snippets are extracted by a html parser.

12. The process of claim 7 further comprising crawling the web in response to the web page priorities.

13. The process of claim 1 where the web page utility prediction process comprises a supervised learning based process.

14. An adaptive web crawling system comprising:
a computer processor;
a full text webpage utility estimation module executable by the computer processor to calculate a webpage utility estimate of a full-text web page based on features extracted from the full-text web page and according to the guidance a utility estimate of webpage snippets;
a feature extractor module executable by the computer processor to extract text features from a web page snippet associated with individual search result items by crawling from a collection of web page crawling seeds before a webpage associated with the web page snippet is downloaded; and
a lightweight webpage utility estimation module executable by the computer processor that adapts priorities for web crawling based on the extracted text features.

15. The system of claim 14 where the lightweight webpage utility estimation module comprises a supervised learning based process.

16. The system of claim 14 where the full-text web page is selected based on multiple step filtering process executable by the computer processor that analyzes the infrequent use of keywords and ratios of key words.

17. The system of claim 16 where the filter processes executes an additive regression process.

18. The system of claim 14 where the full text webpage utility estimation module executable by the computer processor calculates webpage utility estimates of full-text web page in real-time.

19. The system of claim 14 where the real time execution occurs during an internet session.

20. The system of claim 14 where the lightweight webpage utility estimation module indexes the priorities for web crawling.
